(19) United States
(12) Patent Application Publication
(10) Pub. No.: US 2008/0179362 A1
(43) Pub. Date: Jul. 31, 2008

(54) Cigarette lighter holder with built-in clip

(76) Inventors: Daniel Vaysberg, Sunnyvale, CA (US); Geoff Macbride, San Francisco, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/627,853

(22) Filed: Jan. 26, 2007

(51) Int. Cl. A45F 5/00; A47B 96/06; A47G 29/00; B65D 85/00; F23Q 2/36; B60R 7/05; A24F 47/00

(52) U.S. Cl. 224/269; 248/311.2; 206/525; 224/312; 206/85

(57) ABSTRACT

Side stabilizer bars hold a typical disposable lighter. The side stabilizer bars curve approximately 180 degrees to form a built-in clip, allowing the invention to be secured to a car visor or other object. A compartment for a magnet is provided to allow a magnet to further secure the lighter. A bottom stabilizer is used to hold the bottom of the lighter. The invention adds relatively little mass or size to a lighter.

### BACKGROUND OF THE INVENTION

(1) Field of the Invention

The present invention relates generally to holders for lighters such as disposable cigarette lighters.

(2) Description of the Related Art

The related art attempts to provide efficient means to hold or secure cigarette lighters, but fails to provide a universal clip, such as the one disclosed in the invention.

U.S. Pat. No. 5,682,981 by Sudbrough discloses a sleeve that fits under a lighter. A key ring may be placed at the bottom of the Sudbrough device. The key ring may be used to hold a string or other implement to secure the lighter. Attaching or removing the Sudbrough sleeve requires the use of force upon the lighter and sleeve. The sleeve holds the lighter by the use of crude friction from an elastic membrane. Rings, strings and other means of attachment must be added to the Sudbrough holder to secure a lighter to a person or object. The Sudbrough invention adds significant length and weight to a lighter.

What is needed in the art is efficient and self-contained means to secure a lighter to a person or object.

### BRIEF SUMMARY OF THE INVENTION

The invention overcomes shortfalls in the related art by providing built-in means of securing a lighter to other objects. The built-in clip of the invention allows a user to quickly and easily secure a lighter to a person or object. The built-in clip feature is especially well suited for attaching a lighter to the visor of a car.

The invention also overcomes shortfalls in the related art by providing means to quickly attach and detach a holding device on and off a lighter. The invention uses side stabilizers, a magnet and a bottom stabilizer component to allow a user to easily attach and detach a lighter to and from the invention.

The invention solves a long-standing need to make disposable lighters more accessible, retrievable, and convenient to use. Disposable lighters are relatively small and inexpensive and are thus prone to loss. Disposable lighters are used to light or ignite a variety of objects in daylight and in darkness. The invention makes lighters easily attachable to a wide variety of objects, thus keeping the lighters within reach.

The self-contained clip may be used to hold a lighter to a car visor, person's pocket, car door pocket, backpack, brief case flap, computer notebook case, camping stove, camping lantern, hat bill, or other object. No further rings, strings, chains, or clips are needed. No retracting strings or chains are used. The invention does not add significant size or weight to a lighter.

The side stabilizer bars have a dual function of securing the lighter on one side, and securing the invention to a visor or other object on the other side. The side stabilizer bars are curved so as to maintain full contact with a typical disposable lighter, which has a round body. The side stabilizer bars curve backwards at the magnet holder area and form the clip portion of the invention.

Various ornamental designs may be placed in the clip, especially at the magnet area.

These and other aspects of the present invention will become apparent upon reading the following detailed description in conjunction with the associated drawings.

### BRIEF DESCRIPTION OF THE SEVERAL VIEWS OF THE DRAWINGS

FIG. 1 is a front perspective view of the invention.

FIG. 2 is a rear side perspective view of the invention.

FIG. 3 is a side elevation of the invention.

FIG. 4 is an underside perspective view of the invention.

### DETAILED DESCRIPTION OF THE INVENTION

The following detailed description is directed to certain specific embodiments of the invention. However, the invention can be embodied in a multitude of different ways as defined and covered by the claims. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

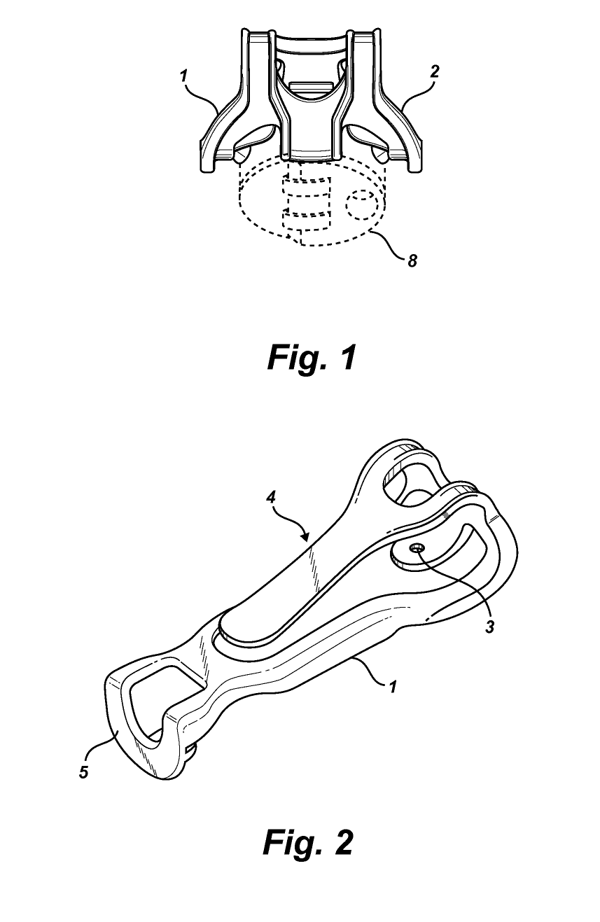

FIG. 1 illustrates front portions of the invention holding a lighter 8. Side stabilizer bars 1 and 2 hold the lighter on either side.

FIG. 2 shows visor clip 4, which may be used to connect the invention to the visor of an automobile. Bottom stabilizer 5 may secure the bottom portion of a lighter. Bottom stabilizer 5 is connected to both side stabilizers 1 and 2. Side stabilizers 1 and 2 curve at the top portion of the invention and connect to the magnet holder 3. The magnet holder may contain a magnet which may help secure the top portion of a lighter.

Side stabilizers 1 and 2 curve behind the magnet holder 3 and from the clip 4. A car visor or other object may be secured between the clip 4 and the backside of the side stabilizer bars 1 and 2. A cigarette lighter may be secured on the bottom stabilizer and further attached by a magnet held in the magnet holder 3. Additional support for the cigarette lighter is provided by the curvature of the side stabilizer bars 1 and 2.

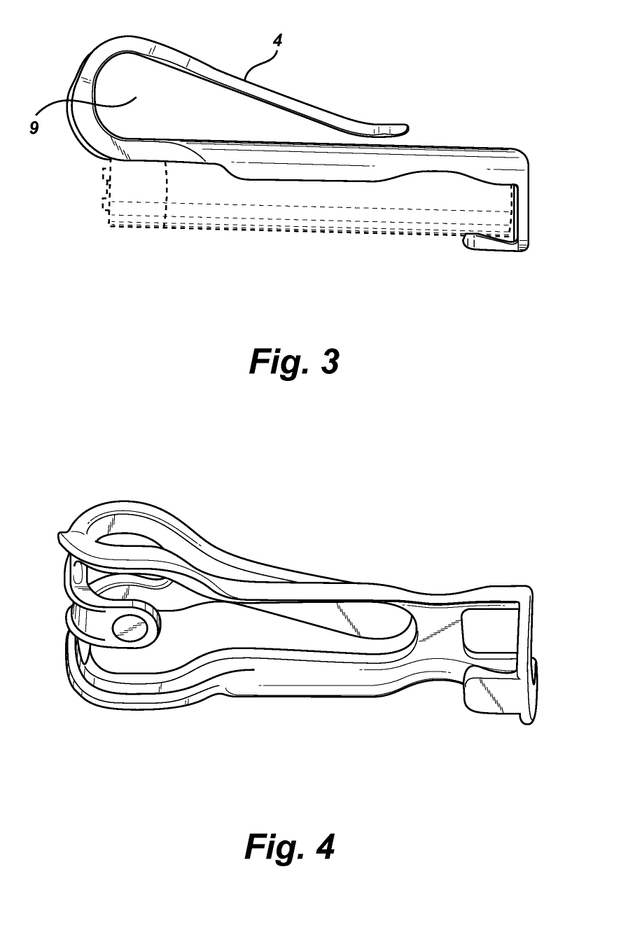

FIG. 3 is a view of the side of the preferred embodiment of the invention. A car visor or other object may be fitted in area 9 between the visor clip 4 and side stabilizer bars.

FIG. 4 shows the invention without holding a lighter.

What is claimed is:

1. An article holding device comprising:
a) an article with a base piece suitable for holding the bottom of an article;
b) two or more side stabilizing bars attached to the base piece on one end and at the other end, curving back toward the base piece.

2. The article of claim 1 wherein the two side stabilizing bars curving back toward the base piece form a clip piece.

3. The article of claim 2 wherein the clip piece is suitable for attaching the device to a car visor.

4. The article of claim 2 wherein the side stabilizing bars have means of securing a magnet.

5. The article of claim 4 wherein the article includes a magnet.

6. A method of securing a lighter comprising:
a) holding the backside of the lighter with two or more stabilizing components;
b) holding the bottom of the lighter with a bottom base piece; and
c) securing the lighter to objects by use of a clip.

7. The method of claim 6 wherein the clip is formed by a curvature of the stabilizing components.

8. The method of claim 7 wherein objects, such as a car visor are fitted between the clip and the stabilizing components.

9. The method of claim 8 wherein a magnet is used to further secure the lighter.

10. A method of holding a lighter comprising:
a) using a clip suitable for attachment to a car visor; and
b) using means to secure the lighter to the clip.

11. The method of claim 10 wherein the lighter is secured to the clip by two or more stabilizing components.

12. The method of claim 11 wherein the stabilizing components are attached to a bottom piece.

13. The method of claim 12 wherein a magnet is used to further secure the lighter.
